(19) United States
(12) Patent Application Publication
(10) Pub. No.: US 2020/0209853 A1
(43) Pub. Date: Jul. 2, 2020

(54) Systems and Methods for Identifying Perception Sensor Degradation

(71) Applicant: UATC, LLC, San Francisco, CA (US)

(72) Inventors: William M. Leach, Pittsburgh, PA (US); Scott C. Poeppel, Pittsburgh, PA (US); Duncan Blake Barber, Pittsburgh, PA (US)

(21) Appl. No.: 16/288,255

(22) Filed: Feb. 28, 2019

Related U.S. Application Data
(60) Provisional application No. 62/786,710, filed on Dec. 31, 2018.

(51) Int. Cl. G05D 1/00; G05D 1/02

(52) U.S. Cl. CPC G05D 1/0077; G05D 1/0088; G05D 1/0231; G05D 2201/0213; G05D 1/0257; G05D 1/027; G05D 1/0272; G05D 1/0255

(57) ABSTRACT

Systems and methods for determining degradation in perception sensors of an autonomous vehicle are provided. A method can include obtaining, by a computing system comprising one or more computing devices, first data from a first sensor of an autonomous vehicle and second data from a second sensor of the autonomous vehicle. The first data and the second data can include detection level data. The computer-implemented method can further include obtaining, by the computing system, third data from the first sensor. The third data can include processed data. The computer-implemented method can further include determining, by the computing system, a sensor degradation condition for the first sensor based at least in part on the first data, the second data, and the third data, and implementing, by the computing system, a sensor correction action for the first sensor based at least in part on the sensor degradation condition.

### PRIORITY CLAIM

The present application is based on and claims benefit of U.S. Provisional Application 62/786,710 having a filing date of Dec. 31, 2018, which is incorporated by reference herein.

### FIELD

The present disclosure relates generally to devices, systems, and methods for identifying and managing perception sensor degradation in autonomous vehicles.

### BACKGROUND

An autonomous vehicle is a vehicle that is capable of sensing its environment and navigating with minimal or no human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can identify an appropriate motion path through such surrounding environment.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for determining degradation in perception sensors of an autonomous vehicle. The computer-implemented method can include obtaining, by a computing system comprising one or more computing devices, first data from a first sensor of an autonomous vehicle and second data from a second sensor of the autonomous vehicle. The first data and the second data can include detection level data. The computer-implemented method can further include obtaining, by the computing system, third data from the first sensor. The third data can include processed data. The computer-implemented method can further include determining, by the computing system, a sensor degradation condition for the first sensor based at least in part on the first data, the second data, and the third data.

Another example aspect of the present disclosure is directed to a computing system. The computing system can include one or more processors and one or more tangible, non-transitory, computer readable media that collectively store instructions that when executed by the one or more processors cause the computing system to perform operations. The operations can include obtaining detection level data from a plurality of sensors of an autonomous vehicle. The operations can further include obtaining processed data from at least one sensor of the autonomous vehicle. The operations can further include determining a sensor degradation condition for a first sensor of the autonomous vehicle based at least in part on the detection level data and the processed data. The operations can further include implementing a sensor correction action for the first sensor based at least in part on the sensor degradation condition.

Another example aspect of the present disclosure is directed to an autonomous vehicle. The autonomous vehicle can include a plurality of sensors. Each sensor of the plurality can be configured to provide detection level data and processed data. The autonomous vehicle can further include one or more processors and one or more tangible, non-transitory, computer readable media that collectively store instructions that when executed by the one or more processors cause a computing system to perform operations. The operations can include obtaining sensor data from each of the plurality of sensors, the sensor data comprising one or more of detection level data and processed data. The operations can further include determining a sensor degradation condition for at least one sensor of the plurality based at least in part on the sensor data from the plurality of sensors. The operations can further include implementing a sensor correction action for the at least one sensor based at least in part on the sensor degradation condition.

Other aspects of the present disclosure are directed to various systems, apparatuses, non-transitory computer-readable media, vehicles, and computing devices.

The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, the autonomous vehicle of the present disclosure may reduce traffic congestion in communities as well as provide alternate forms of transportation that may provide environmental benefits.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example autonomous vehicle computing system according to example aspects of the present disclosure;

FIG. 2 depicts an example sensor according to example aspects of the present disclosure;

FIG. 3 depicts a plurality of example sensors and corresponding fields of view according to example aspects of the present disclosure;

FIG. 4A depicts an example method according to example aspects of the present disclosure;

FIG. 4B depicts an example method according to example aspects of the present disclosure;

FIG. 5 depicts an example method according to example aspects of the present disclosure;

FIG. 6 depicts an example system with units for performing operations and functions according to example aspects of the present disclosure; and

FIG. 7 depicts example system components according to example aspects of the present disclosure.

### DETAILED DESCRIPTION

Example aspects of the present disclosure are directed to improved techniques for evaluating the condition of a sensor of an autonomous vehicle. An autonomous vehicle can drive, navigate, operate, etc. with minimal and/or no interaction from a human driver to provide a vehicle service. By way of example, an autonomous vehicle can be configured to provide transportation and/or other services, such as transporting a passenger from a first location to a second location. The autonomous vehicle can include a plurality of sensors to perceive and navigate through the surrounding environment. For example, detection level data from one or more sensors can be analyzed by a computing system to detect objects within the surrounding environment, such as via a perception system. In some implementations, sensors of an autonomous vehicle can be configured to obtain both detection level data (e.g., raw or minimally processed data indicative of the surrounding environment) as well as processed data (e.g., data processed by one or more algorithms, such as data indicative of an object state and/or tracked object data). For example, individual sensors can include filters, object tracking modules, command modules, etc. as part of a processed data pipeline in order to track objects within the surrounding environment. Further, in some implementations, the processed data can be used to provide vehicle actuator commands. For example, a sensor can be configured to track an object, such as over a period of time, and provide a vehicle actuator command (e.g., a brake command) in response to the tracked object. However, during operation of the autonomous vehicle, sensors of the autonomous vehicle may experience various degradation conditions, such as misalignment of a sensor, occlusion of the sensor, or internal sensor defects.

The systems and methods of the present disclosure can help determine a sensor degradation condition for one or more sensors of an autonomous vehicle, and further, implement a sensor correction action based at least in part on the sensor degradation condition. For example, a computing system can include one or more computing devices, and can be configured to obtain data from sensors of an autonomous vehicle. In some implementations, the sensors can be LIDAR sensors, ultrasonic sensors, RADAR sensors, inertial measurement units, wheel encoders, steering angle sensors, positioning sensors (e.g., GPS sensors), cameras sensors, and/or other sensors. As an example, the computing system can obtain detection level data and processed data from a first sensor, and further can obtain detection level from a second sensor. The computing system can then determine that first the sensor is experiencing a sensor degradation condition based at least in part on the sensor data. For example, in some implementations, the computing system can aggregate the detection level data from the first sensor and the second sensor to determine aggregated data indicative of a state of an object, and compare the aggregated data to the processed data obtained from the first sensor to determine whether the first sensor is experiencing a sensor degradation condition. For example, the first sensor may be misaligned, experiencing an occlusion, or experiencing an internal defect. The computing system can then implement a sensor correction action for the first sensor based at least in part on the sensor degradation condition. For example, in some implementations, the computing system can adjust a weight parameter of the first sensor, schedule maintenance, clean the sensor, perform one or more sensor diagnostic actions, and/or implement a safe stop action for the autonomous vehicle.

More particularly, an autonomous vehicle (e.g., ground-based vehicle, etc.) can include various systems and devices configured to control the operation of the vehicle. For example, an autonomous vehicle can include an onboard vehicle computing system (e.g., located on or within the autonomous vehicle) that is configured to operate the autonomous vehicle. The vehicle computing system can obtain sensor data from sensor(s) onboard the vehicle (e.g., cameras, LIDAR, RADAR, etc.), attempt to comprehend the vehicle's surrounding environment by performing various processing techniques on the sensor data, and generate an appropriate motion plan through the vehicle's surrounding environment. Moreover, an autonomous vehicle can include a communications system that can allow the vehicle to communicate with a computing system that is remote from the vehicle such as, for example, that of a service entity.

For example, one or more sensors of the autonomous vehicle can obtain sensor data associated with objects within the surrounding environment of the autonomous vehicle. In some implementations, the perception system can receive the sensor data and generate state data indicative of the one or more objects, such as data describing the position, velocity, heading, acceleration, yaw rate, size, type, distance from the autonomous vehicle, etc. for each object. As an example, detection level data from a plurality of sensors can be aggregated by the computing system (e.g., the perception system) in order to determine state data indicative of the one or more objects in the surrounding environment. In some implementations, a prediction system can create prediction data associated with each respective object within the surrounding environment, which can be indicative of one or more predicted future locations and/or trajectories of each respective object. In some implementations, a motion planning system can then determine a motion plan for the autonomous vehicle based on the predicted locations and/or trajectories for the objects. For example, the motion planning system can determine the motion plan for the autonomous vehicle to navigate around and/or in response to the perceived objects and their predicted trajectories.

According to example aspects of the present disclosure, sensors of an autonomous vehicle can also be configured to provide processed data as well as detection level data. For example, a LIDAR sensor (or other sensor) can have a first processing pipeline which generates detection level data. The detection level data can be, for example, a point cloud representative of the surrounding environment and objects within the surrounding environment. The detection level data can also be referred to as raw data or minimally processed data. The LIDAR sensor can also have a second processing pipeline which can generate processed data. For example, the second processing pipeline can include various filters, signal processing components, object tracking modules, actuator command modules, processors, components, and/or other modules configured to process sensor data obtained by the sensor. Stated differently, the second processing pipeline can be a pipeline which implements various algorithms on sensor data obtained by the sensor, such as detection level data, to generate the processed data.

In some implementations, the processed data can be state data indicative of a state of an object detected by the sensor. For example, in some implementations, a sensor (e.g., RADAR sensor, camera, LIDAR sensor, etc.) can obtain detection level data over a plurality of iterations, and can generate state data for one or more objects detected by the sensor by, for example, tracking the object over the plurality of iterations.

According to example aspects of the present disclosure, a computing system can obtain sensor data, such as detection level data and/or processed data, from a plurality of sensors, and can determine a sensor degradation condition for at least one sensor of an autonomous vehicle based at least in part on the sensor data.

For example, in some implementations, the computing system can obtain first data (e.g., detection level data) from a first sensor and second data (e.g., detection level data) from a second sensor. The computing system can further obtain third data (e.g., processed data) from the first sensor. In various implementations, the computing system can obtain sensor data from any number of additional sensors, such as fourth data (e.g., detection level data or processed data) from a third sensor.

In some implementations, the first sensor and the second sensor (or any number of sensors) can be the same type of sensor. For example, two sensors can both be LIDAR sensors, RADAR sensors, camera sensors, etc. In some implementations, the first sensor and the second sensor can be different types of sensors. For example, the first sensor can be a LIDAR sensor, and the second sensor can be a RADAR sensor. In implementations in which the first sensor and the second sensor are of different types, the computing system can compare common attributes of the respective sensor data, such as data indicative of objects perceived by the respective sensors. In some implementations, the respective sensor data can include data indicative of object types, positions, velocities, etc.

The computing system can then determine a sensor degradation condition for a sensor based at least in part on the sensor data. For example, in some implementations, the computing system can obtain detection level data from a plurality of sensors. The detection level data from the plurality of sensors can then be aggregated (e.g., combined) to determine aggregated data, which can be indicative of a state of an object detected by the plurality of sensors. For example, the aggregated data can be indicative of an object's position, velocity, acceleration, heading, yaw rate, shape, size, type, or distance from the autonomous vehicle.

The computing system can then compare processed data received from at least one sensor with the aggregated data to determine whether a sensor is operating properly. For example, if processed data from a first sensor indicates an object is a particular object type (e.g., a tree), whereas aggregated data from a plurality of sensors indicates that the object is a different object type (e.g., a bicycle), the mismatch can indicate the first sensor is not operating properly.

Similarly, if the processed data from the first sensor does not perceive the particular object (e.g., the sensor does not “see” or otherwise detect the particular object), whereas aggregated data from a plurality of sensors does perceive the particular object, the computing system may determine that first sensor is experiencing a sensor degradation condition. For example, something may be defective with the first sensor (e.g., an internal defect may be preventing the first sensor from perceiving the object), the sensor may be misaligned such that the object is not within the field of view of the first sensor, or an occlusion may be preventing the first sensor from perceiving the object (e.g., another object or debris is blocking the field of view of the first sensor).

As another example, if aggregated data from a plurality of sensors is indicative of a particular state of a particular object, and processed data from a first sensor (e.g. a sensor in the plurality or a sensor not in the plurality) is also indicative of the particular state of the particular object (e.g., the processed data from the first sensor confirms the aggregated data), the computing system may determine that the first sensor is not experiencing a sensor degradation condition. If, however, processed data from a second sensor (e.g., a sensor in the plurality or a sensor not in the plurality) is not indicative of the particular state of the particular object (e.g., the processed data from the second sensor conflicts with the aggregated data and/or the processed data from the first sensor), the computing system can determine that the second sensor is experiencing a sensor degradation condition. Thus, detection level data from a plurality of sensors and/or processed data from one or more sensors can be used to determine whether a particular sensor is experiencing a sensor degradation condition.

In some situations, a plurality of sensors may each perceive a particular object via processed data generated by the sensors (e.g., multiple sensors each respectively detect an object via a processed data pipeline), whereas the processed data from a particular sensor with an overlapping field of view does not. In such a situation, the computing system can determine that the particular sensor may be experiencing a sensor degradation condition, such as an occlusion condition, misalignment condition, or defective condition.

In some implementations, the computing system can be configured to account for sensor data latency differences. For example, processed data generated by a particular sensor may have a slower latency as compared to detection level data generated by the same or other sensors. The computing system can be configured to account for such latency differences by, for example, selecting detection level data and processed data from corresponding time periods for comparison.

In some implementations, the computing system can determine whether a sensor degradation condition is a temporary sensor degradation condition for a permanent sensor degradation condition. For example, the computing system may be able to run one or more diagnostics on a sensor experiencing a sensor degradation condition in order to determine whether the sensor degradation condition is temporary (e.g., a blocked field of view) or permanent (e.g., an internal defect). For example, imagery processing techniques can be used to determine whether debris is occluding a camera, or an object perceived by one or more sensors as the autonomous vehicle proceeds along a motion path can be determined to be blocking a field of view of another sensor.

In some implementations, the computing system can determine that a particular sensor is experiencing a misalignment condition by, for example, using known relationships between the orientation of various sensors. For example, if a first sensor has an overlapping field of view with a second sensor, and the first sensor generates processed data indicating an object should be located in a particular portion of the second sensor's field of view, but processed data from the second sensor indicates the object is within a different portion of the second sensor's field of view, the computing system can determine that the second sensor may be experiencing a misalignment condition. Similarly, aggregated detection level data from a plurality of sensors can be compared to processed data from a particular sensor to determine whether the particular sensor is experiencing a misalignment condition.

In this way, a computing system can determine whether a sensor is experiencing a sensor degradation condition using detection level data and processed data from a plurality of sensors. Further, in some implementations, the computing system can implement a sensor correction action based at least in part on the sensor degradation condition.

For example, in some implementations, the sensor correction action can include adjusting a weighting parameter associated with a sensor. For example, a perception system can assign respective weighting parameters to each of a plurality of sensors which provide detection level data when the detection level data is aggregated by the perception system. The weighting parameters can correspond to a respective confidence level for each sensor. For example, if sensor data from a particular sensor contains a high level of noise or if a particular sensor has a low confidence level in an object classification, the perception system can deprioritize that sensor as compared to one or more other sensors of the autonomous vehicle. Similarly, the perception system can deprioritize either the detection level data or the processed data as compared to the other of the two. For example, the perception system can assign a higher weighting parameter to processed data and a lower weighting parameter to the detection level data from a particular sensor. In some implementations, adjusting a weighting parameter can include ignoring one or more sensor data streams from a particular sensor.

In some implementations, a sensor correction action can include scheduling maintenance for a sensor. For example, a computing system onboard an autonomous vehicle can communicate with a remote computing system, and can schedule the autonomous vehicle to be routed to an autonomous vehicle inspection facility for maintenance.

In some implementations, a sensor correction action can include cleaning a sensor. For example, an autonomous vehicle may be equipped with a sensor cleaning system, which can use liquid and/or gas sensor cleaning units to clean sensors of the autonomous vehicle. For example, when the computing system determines that a camera sensor is experiencing a temporary occlusion condition, such as debris on a lens of the camera, the computing system can cause the sensor cleaning system to clean the debris from the lens of the camera.

In some implementations, a sensor correction action can include performing a sensor diagnostic action on a sensor. For example, in some implementations, a sensor can be configured to run one or more diagnostic algorithms to evaluate whether a sensor is operating correctly. In some implementations, the diagnostic algorithms can be performed as part of a processed data pipeline. In some implementations, the diagnostic algorithms can be performed as part of a perception system, such as by aggregating detection level data and evaluating the aggregated data using a diagnostic algorithm.

In some implementations, a sensor correction action can include operating the autonomous vehicle to a safe state in which autonomous operation is disabled. For example, if a sensor is experiencing a defective condition, such as due to an internal defect, the computing system can implement a motion plan to operate the vehicle to a safe state, such as navigating the autonomous vehicle to a stop in a parking lot, and autonomous operation can be disabled. In some implementations, the autonomous vehicle may only be able to operate in a manual operating mode until the sensor degradation condition has been remedied, such as by repairing or replacing the sensor.

The systems and methods described herein provide a number of technical effects and benefits. More particularly, the systems and methods of the present disclosure provide improved techniques for evaluating whether sensors of an autonomous vehicle are operating properly. For example, as described herein, a computing system can determine when a sensor is experiencing a sensor degradation condition based at least in part on detection level data and processed data from a plurality of sensors. For example, detection level data from a plurality of sensors can be aggregated, and the aggregated data can be compared to processed data from a particular sensor in order to determine whether the particular sensor is operating properly. Moreover, when a sensor is experiencing a sensor degradation condition, the systems methods of the present disclosure can allow for a sensor correction action to be implemented, such as performing diagnostics, scheduling maintenance, cleaning a sensor, adjusting weighting parameters, etc.

In turn, the systems and methods described herein can improve the safety of autonomous vehicle operation. For example, by identifying when a sensor is experiencing a degradation condition, such degradation conditions can be mitigated by implementing one or more corrective actions. In some implementations, temporary degradation conditions can be mitigated concurrently with operation of the autonomous vehicle. For example, when a sensor is experiencing a temporary degradation condition, such as when a sensor's field of view is blocked, the computing system can deprioritize the sensor to allow for other sensors which do not have a blocked field of view to be used for autonomous vehicle operation. Further, when a sensor is experiencing a permanent degradation condition, an autonomous vehicle can be scheduled to undergo maintenance and/or operated to a safe state to allow for the sensor to be repaired or replaced. Thus, the systems and methods of the present disclosure can allow for reduced autonomous vehicle downtime by addressing temporary degradation conditions concurrently with autonomous operation, while allowing for permanent degradation conditions to be addressed in a safe manner.

Moreover, the systems and methods of the present disclosure can leverage parallel data processing pipelines of autonomous vehicle sensors in order to evaluate individual sensor health. For example, a processed data stream from a particular sensor can be used to evaluate whether the particular sensor or another sensor is experiencing a sensor degradation condition. By leveraging parallel processing pipelines, sensor health can be evaluated concurrently with sensor operation without adversely impacting sensor operation. Thus, the systems methods of the present disclosure can allow for more efficient evaluation of sensor operation.

Example aspects of the present disclosure can provide an improvement to vehicle computing technology, such as autonomous vehicle computing technology. For example, the systems and methods of the present disclosure provide an improved approach to evaluating operation of sensors of an autonomous vehicle. For example, a computing system (e.g., a computing system on board an autonomous vehicle) can obtain detection level data from a plurality of sensors of an autonomous vehicle. The computing system can further obtain processed data from at least one sensor of the autonomous vehicle. In some implementations, the processed data can be data indicative of a state of an object. The computing system can then determine a sensor degradation condition for a first sensor of the autonomous vehicle based at least in part on the detection level data and the processed data. For example, in some implementations, the detection level data from the plurality of sensors can be aggregated, and the aggregated data can be compared to the processed data. In some implementations, the computing system can determine whether a sensor is experiencing a misalignment condition, an occlusion condition, a defective condition, a temporary degradation condition, or a permanent degradation condition. The computing system can then implement a sensor correction action for the first sensor based at least in part on the sensor degradation condition. For example, in some implementations, the computing system can adjust a weighting parameter of the first sensor, schedule maintenance for the first sensor, clean the first sensor, perform a sensor diagnostic action on the first sensor, or implement a safe stop action for the autonomous vehicle. This allows for a more efficient use of the processing, memory, and power resources of the vehicle's computing system by leveraging parallel data streams from sensors.

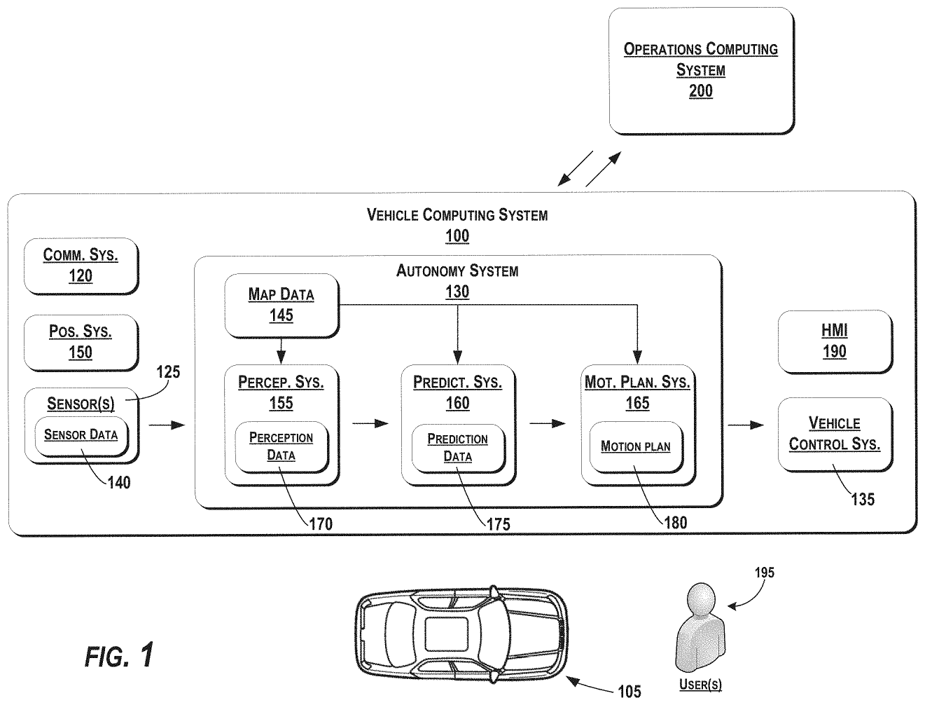

With reference now to the FIGS., example aspects of the present disclosure will be discussed in further detail. FIG. 1 illustrates an example vehicle computing system 100 according to example aspects of the present disclosure. The vehicle computing system 100 can be associated with an autonomous vehicle 105. The vehicle computing system 100 can be located onboard (e.g., included on and/or within) the autonomous vehicle 105.

The autonomous vehicle 105 incorporating the vehicle computing system 100 can be various types of vehicles. For instance, the autonomous vehicle 105 can be a ground-based autonomous vehicle such as an autonomous car, autonomous truck, autonomous bus, etc. The autonomous vehicle 105 can be an air-based autonomous vehicle (e.g., airplane, helicopter, or other aircraft) or other types of vehicles (e.g., watercraft, etc.). The autonomous vehicle 105 can drive, navigate, operate, etc. with minimal and/or no interaction from a human operator (e.g., driver). In some implementations, a human operator can be omitted from the autonomous vehicle 105 (and/or also omitted from remote control of the autonomous vehicle 105). In some implementations, a human operator can be included in the autonomous vehicle 105.

In some implementations, the autonomous vehicle 105 can be configured to operate in a plurality of operating modes. The autonomous vehicle 105 can be configured to operate in a fully autonomous (e.g., self-driving) operating mode in which the autonomous vehicle 105 is controllable without user input (e.g., can drive and navigate with no input from a human operator present in the autonomous vehicle 105 and/or remote from the autonomous vehicle 105). The autonomous vehicle 105 can operate in a semi-autonomous operating mode in which the autonomous vehicle 105 can operate with some input from a human operator present in the autonomous vehicle 105 (and/or a human operator that is remote from the autonomous vehicle 105). The autonomous vehicle 105 can enter into a manual operating mode in which the autonomous vehicle 105 is fully controllable by a human operator (e.g., human driver, pilot, etc.) and can be prohibited and/or disabled (e.g., temporary, permanently, etc.) from performing autonomous navigation (e.g., autonomous driving). In some implementations, the autonomous vehicle 105 can implement vehicle operating assistance technology (e.g., collision mitigation system, power assist steering, etc.) while in the manual operating mode to help assist the human operator of the autonomous vehicle 105.

The operating modes of the autonomous vehicle 105 can be stored in a memory onboard the autonomous vehicle 105. For example, the operating modes can be defined by an operating mode data structure (e.g., rule, list, table, etc.) that indicates one or more operating parameters for the autonomous vehicle 105, while in the particular operating mode. For example, an operating mode data structure can indicate that the autonomous vehicle 105 is to autonomously plan its motion when in the fully autonomous operating mode. The vehicle computing system 100 can access the memory when implementing an operating mode.

The operating mode of the autonomous vehicle 105 can be adjusted in a variety of manners. For example, the operating mode of the autonomous vehicle 105 can be selected remotely, off-board the autonomous vehicle 105. For example, a remote computing system (e.g., of a vehicle provider and/or service entity associated with the autonomous vehicle 105) can communicate data to the autonomous vehicle 105 instructing the autonomous vehicle 105 to enter into, exit from, maintain, etc. an operating mode. By way of example, such data can instruct the autonomous vehicle 105 to enter into the fully autonomous operating mode. In some implementations, the operating mode of the autonomous vehicle 105 can be set onboard and/or near the autonomous vehicle 105. For example, the vehicle computing system 100 can automatically determine when and where the autonomous vehicle 105 is to enter, change, maintain, etc. a particular operating mode (e.g., without user input). Additionally, or alternatively, the operating mode of the autonomous vehicle 105 can be manually selected via one or more interfaces located onboard the autonomous vehicle 105 (e.g., key switch, button, etc.) and/or associated with a computing device proximate to the autonomous vehicle 105 (e.g., a tablet operated by authorized personnel located near the autonomous vehicle 105). In some implementations, the operating mode of the autonomous vehicle 105 can be adjusted by manipulating a series of interfaces in a particular order to cause the autonomous vehicle 105 to enter into a particular operating mode.

The vehicle computing system 100 can include one or more computing devices located onboard the autonomous vehicle 105. For example, the computing device(s) can be located on and/or within the autonomous vehicle 105. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the autonomous vehicle 105 (e.g., its computing system, one or more processors, etc.) to perform operations and functions, such as those described herein for determining sensor degradation conditions and implementing sensor corrective actions, etc.

The autonomous vehicle 105 can include a communications system 120 configured to allow the vehicle computing system 100 (and its computing device(s)) to communicate with other computing devices. The vehicle computing system 100 can use the communications system 120 to communicate with one or more computing device(s) that are remote from the autonomous vehicle 105 over one or more networks (e.g., via one or more wireless signal connections). For example, the communications system 120 can allow the autonomous vehicle to communicate and receive data from an operations computing system 200 of a service entity. In some implementations, the communications system 120 can allow communication among one or more of the system(s) on-board the autonomous vehicle 105. The communications system 120 can include any suitable components for interfacing with one or more network(s), including, for example, transmitters, receivers, ports, controllers, antennas, and/or other suitable components that can help facilitate communication.

As shown in FIG. 1, the autonomous vehicle 105 can include one or more vehicle sensors 125, an autonomy computing system 130, one or more vehicle control systems 135, and other systems, as described herein. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can send and/or receive data, messages, signals, etc. amongst one another via the communication channel.

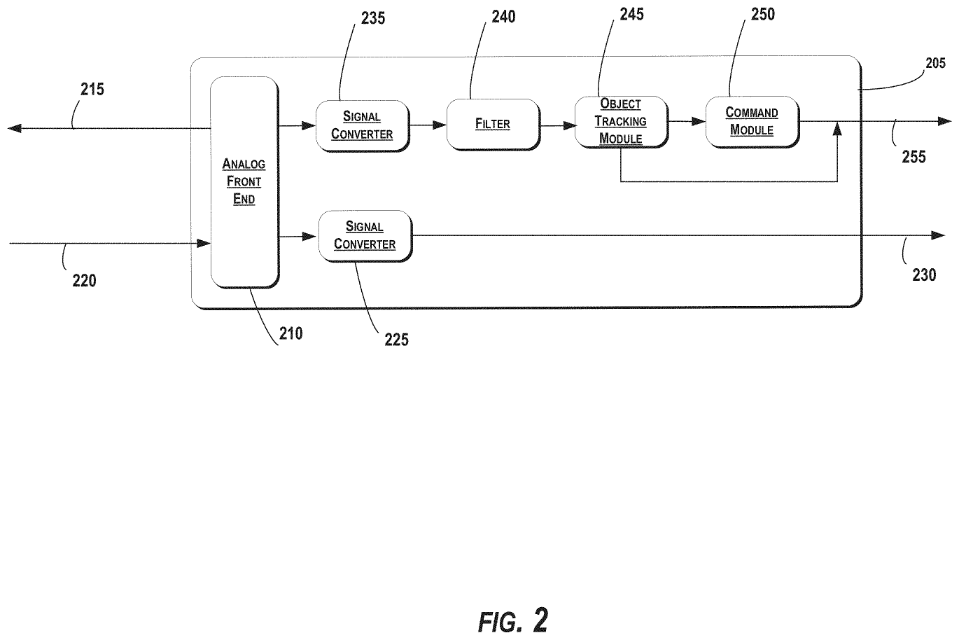

The vehicle sensor(s) 125 can be configured to acquire sensor data 140. This can include sensor data associated with the surrounding environment of the autonomous vehicle 105. For instance, the sensor data 140 can acquire image and/or other data within a field of view of one or more of the vehicle sensor(s) 125. The vehicle sensor(s) 125 can include a Light Detection and Ranging (LIDAR) system, a Radio Detection and Ranging (RADAR) system, one or more cameras (e.g., visible spectrum cameras, infrared cameras, etc.), ultrasonic sensors, wheel encoders, steering angle encoders, positioning sensors (e.g., GPS sensors), inertial measurement units, motion sensors, and/or other types of imaging capture devices and/or sensors. The sensor data 140 can include image data, RADAR data, LIDAR data, and/or other data acquired by the vehicle sensor(s) 125. The autonomous vehicle 105 can include other sensors configured to acquire data associated with the autonomous vehicle 105. For example, the autonomous vehicle 105 can include inertial measurement unit(s), and/or other sensors. The sensor data 140 can include detection level data and/or processed data, as discussed in greater detail with respect to FIG. 2.

In some implementations, the sensor data 140 can be indicative of one or more objects within the surrounding environment of the autonomous vehicle 105. The object(s) can include, for example, vehicles, pedestrians, bicycles, and/or other objects. The object(s) can be located in front of, to the rear of, to the side of the autonomous vehicle 105, etc. The sensor data 140 can be indicative of locations associated with the object(s) within the surrounding environment of the autonomous vehicle 105 at one or more times. The vehicle sensor(s) 125 can communicate (e.g., transmit, send, make available, etc.) the sensor data 140 to the autonomy computing system 130.

In addition to the sensor data 140, the autonomy computing system 130 can retrieve or otherwise obtain map data 145. The map data 145 can provide information about the surrounding environment of the autonomous vehicle 105. In some implementations, an autonomous vehicle 105 can obtain detailed map data that provides information regarding: the identity and location of different roadways, road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); the location of obstructions (e.g., roadwork, accidents, etc.); data indicative of events (e.g., scheduled concerts, parades, etc.); and/or any other map data that provides information that assists the autonomous vehicle 105 in comprehending and perceiving its surrounding environment and its relationship thereto. In some implementations, the vehicle computing system 100 can determine a vehicle route for the autonomous vehicle 105 based at least in part on the map data 145.

The autonomous vehicle 105 can include a positioning system 150. The positioning system 150 can determine a current position of the autonomous vehicle 105. The positioning system 150 can be any device or circuitry for analyzing the position of the autonomous vehicle 105. For example, the positioning system 150 can determine position by using one or more of inertial sensors (e.g., inertial measurement unit(s), etc.), a satellite positioning system, based on IP address, by using triangulation and/or proximity to network access points or other network components (e.g., cellular towers, WiFi access points, etc.) and/or other suitable techniques. The position of the autonomous vehicle 105 can be used by various systems of the vehicle computing system 100 and/or provided to a remote computing system. For example, the map data 145 can provide the autonomous vehicle 105 relative positions of the elements of a surrounding environment of the autonomous vehicle 105. The autonomous vehicle 105 can identify its position within the surrounding environment (e.g., across six axes, etc.) based at least in part on the map data 145. For example, the vehicle computing system 100 can process the sensor data 140 (e.g., LIDAR data, camera data, etc.) to match it to a map of the surrounding environment to get an understanding of the vehicle's position within that environment.

The autonomy computing system 130 can include a perception system 155, a prediction system 160, a motion planning system 165, and/or other systems that cooperate to perceive the surrounding environment of the autonomous vehicle 105 and determine a motion plan 180 for controlling the motion of the autonomous vehicle 105 accordingly. For example, the autonomy computing system 130 can obtain the sensor data 140 from the vehicle sensor(s) 125, process the sensor data 140 (and/or other data) to perceive its surrounding environment, predict the motion of objects within the surrounding environment, and generate an appropriate motion plan 180 through such surrounding environment. The autonomy computing system 130 can communicate with the one or more vehicle control systems 135 to operate the autonomous vehicle 105 according to the motion plan 180.

The vehicle computing system 100 (e.g., the autonomy computing system 130) can identify one or more objects that are proximate to the autonomous vehicle 105 based at least in part on the sensor data 140 and/or the map data 145. For example, the vehicle computing system 100 (e.g., the perception system 155) can process the sensor data 140, the map data 145, etc. to obtain perception data 170. The vehicle computing system 100 can generate perception data 170 that is indicative of one or more states (e.g., current and/or past state(s)) of a plurality of objects that are within a surrounding environment of the autonomous vehicle 105. For example, the perception data 170 for each object can describe (e.g., for a given time, time period) an estimate of the object's: current and/or past location (also referred to as position); current and/or past speed/velocity; current and/or past acceleration; current and/or past heading; current and/or past orientation; a shape; a size/footprint (e.g., as represented by a bounding shape); a type/class (e.g., pedestrian class vs. vehicle class vs. bicycle class), a distance from the autonomous vehicle 105; the uncertainties associated therewith, and/or other state information. The perception system 155 can provide the perception data 170 to the prediction system 160 (and/or the motion planning system 165).

In some implementations, the vehicle computing system 100 can aggregate sensor data 140 (e.g., detection level data) from a plurality of sensors 125. For example, in some implementations, detection level data from a plurality of sensors 125 can be aggregated by a perception system 155, while in other implementations, any suitable computing system 100 can be used to aggregate detection level data. The sensor data 140 (e.g., detection level data) can be aggregated by combining the sensor data 140 to create a consolidated view of objects in space. Stated differently, the detection level data from the sensors 125 can be fused, combined, rectified, or otherwise aggregated to determine one or more properties regarding objects perceived by an autonomous vehicle 105. In some implementations, the aggregated data can include state data descriptive of a state of the object, such as data indicative of a position, a velocity, an acceleration, a heading, a yaw rate, a shape, a size, an object type, and/or a distance from the autonomous vehicle 105 (or the sensor 125), as described herein.

For example, data from certain types of sensors 125 may be better for determining certain properties of objects as compared to other types of sensors 125, but less useful in determining other properties of objects. For example, detection level data from a RADAR sensor 125 and/or a LIDAR sensor 125 may be useful in determining the distance of an object from an autonomous vehicle 105 (e.g., in a longitudinal direction), but may be less useful in determining an orientation or a lateral position of the object in the surrounding environment. Similarly, detection level data from a camera sensor 125 may be useful in determining a lateral position and/or an orientation of the object in relation to the autonomous vehicle 105, but may be less useful in determining how far away from the autonomous vehicle 105 the object is located (e.g., in the longitudinal direction). Thus, as an example, the vehicle computing system 100 (e.g., the perception system 155) can aggregate sensor data 140 (e.g., detection level data) from the LIDAR/RADAR sensor(s) 125 and the camera sensor 125 to determine an exact position and orientation of the object in relation to the autonomous vehicle 105 by combining attributes of the sensor data 140 from the sensors 125.

As another example, a vehicle computing system 100 (e.g., the perception system 155) can aggregate detection level data from a plurality of sensors 125 of the same type, such as two RADAR sensors 125 with overlapping fields of view. For example, detection level data from a first RADAR sensor 125 located at a front bumper and detection level data from a second RADAR sensor 125 located at a rear bumper can be aggregated to determine a position of an object within the fields of view of both sensors 125, such as by using known relationships regarding the spacing and orientation of the RADAR sensors 125.

The prediction system 160 can be configured to predict a motion of the object(s) within the surrounding environment of the autonomous vehicle 105. For instance, the prediction system 160 can generate prediction data 175 associated with such object(s). The prediction data 175 can be indicative of one or more predicted future locations of each respective object. For example, the prediction system 160 can determine a predicted motion trajectory along which a respective object is predicted to travel over time. A predicted motion trajectory can be indicative of a path that the object is predicted to traverse and an associated timing with which the object is predicted to travel along the path. The predicted path can include and/or be made up of a plurality of way points. In some implementations, the prediction data 175 can be indicative of the speed and/or acceleration at which the respective object is predicted to travel along its associated predicted motion trajectory. The prediction system 160 can output the prediction data 175 (e.g., indicative of one or more of the predicted motion trajectories) to the motion planning system 165.

The vehicle computing system 100 (e.g., the motion planning system 165) can determine a motion plan 180 for the autonomous vehicle 105 based at least in part on the perception data 170, the prediction data 175, and/or other data. A motion plan 180 can include vehicle actions (e.g., planned vehicle trajectories, speed(s), acceleration(s), other actions, etc.) with respect to one or more of the objects within the surrounding environment of the autonomous vehicle 105 as well as the objects' predicted movements. For instance, the motion planning system 165 can implement an optimization algorithm, model, etc. that considers cost data associated with a vehicle action as well as other objective functions (e.g., cost functions based on speed limits, traffic lights, etc.), if any, to determine optimized variables that make up the motion plan 180. The motion planning system 165 can determine that the autonomous vehicle 105 can perform a certain action (e.g., pass an object, etc.) without increasing the potential risk to the autonomous vehicle 105 and/or violating any traffic laws (e.g., speed limits, lane boundaries, signage, etc.). For instance, the motion planning system 165 can evaluate one or more of the predicted motion trajectories of one or more objects during its cost data analysis as it determines an optimized vehicle trajectory through the surrounding environment. The motion planning system 165 can generate cost data associated with such trajectories. In some implementations, one or more of the predicted motion trajectories may not ultimately change the motion of the autonomous vehicle 105 (e.g., due to an overriding factor). In some implementations, the motion plan 180 may define the vehicle's motion such that the autonomous vehicle 105 avoids the object(s), reduces speed to give more leeway to one or more of the object(s), proceeds cautiously, performs a stopping action, etc.

The motion planning system 165 can be configured to continuously update the vehicle's motion plan 180 and a corresponding planned vehicle motion trajectory. For example, in some implementations, the motion planning system 165 can generate new motion plan(s) 180 for the autonomous vehicle 105 (e.g., multiple times per second). Each new motion plan 180 can describe a motion of the autonomous vehicle 105 over the next planning period (e.g., next several seconds). Moreover, a new motion plan 180 may include a new planned vehicle motion trajectory. Thus, in some implementations, the motion planning system 165 can continuously operate to revise or otherwise generate a short-term motion plan based on the currently available data. Once the optimization planner has identified the optimal motion plan 180 (or some other iterative break occurs), the optimal motion plan 180 (and the planned motion trajectory) can be selected and executed by the autonomous vehicle 105.

The vehicle computing system 100 can cause the autonomous vehicle 105 to initiate a motion control in accordance with at least a portion of the motion plan 180. A motion control can be an operation, action, etc. that is associated with controlling the motion of the vehicle. For instance, the motion plan 180 can be provided to the vehicle control system(s) 135 of the autonomous vehicle 105. The vehicle control system(s) 135 can be associated with a vehicle controller (e.g., including a vehicle interface) that is configured to implement the motion plan 180. The vehicle controller can, for example, translate the motion plan 180 into instructions for the appropriate vehicle control component (e.g., acceleration control, brake control, steering control, etc.). By way of example, the vehicle controller can translate a determined motion plan 180 into instructions to adjust the steering of the autonomous vehicle 105 “X” degrees, apply a certain magnitude of braking force, etc. The vehicle controller (e.g., the vehicle interface) can help facilitate the responsible vehicle control (e.g., braking control system, steering control system, acceleration control system, etc.) to execute the instructions and implement the motion plan 180 (e.g., by sending control signal(s), making the translated plan available, etc.). This can allow the autonomous vehicle 105 to autonomously travel within the vehicle's surrounding environment.

The autonomous vehicle 105 can include an HMI (“Human Machine Interface”) 190 that can output data for and accept input from a user 195 of the autonomous vehicle 105. The HMI 190 can include one or more output devices such as display devices, speakers, tactile devices, etc. For instance, the autonomous vehicle 105 can include a plurality of display devices. The display devices can include smart glass technology, a display screen, CRT, LCD, plasma screen, touch screen, TV, projector, other types of display devices and/or a combination thereof. One or more of the display devices can be included in a user device (e.g., personal computer, tablet, mobile phone, etc.).

The plurality of display devices can include a first display device and a second display device. The first display device can be associated with the exterior of the autonomous vehicle 105. The first display device can be located on an exterior surface and/or other structure, of the autonomous vehicle 105 and/or configured such that a user 195 can view and/or interact with the first display device (and/or a user interface rendered thereon) from the exterior of the autonomous vehicle 105. For example, one or more windows of the autonomous vehicle 105 can include smart glass technology that can perform as the first display device. The second display device can be associated with the interior of the autonomous vehicle 105. The second display device can be located on an interior surface and/or other structure (e.g., seat, etc.) of the autonomous vehicle 105 and/or configured such that a user can view and/or interact with the second display device (and/or a user interface rendered thereon) from the interior of the autonomous vehicle 105. For example, a user device (e.g., tablet, etc.) located within the interior of the autonomous vehicle 105 can include the second display device.

The autonomous vehicle 105 can be associated with a variety of different parties. In some implementations, the autonomous vehicle 105 can be associated with a vehicle provider. The vehicle provider can include, for example, an owner, a manufacturer, a vendor, a manager, a coordinator, a handler, etc. of the autonomous vehicle 105. The vehicle provider can be an individual, a group of individuals, an entity (e.g., a company), a group of entities, a service entity, etc. In some implementations, the autonomous vehicle 105 can be included in a fleet of vehicles associated with the vehicle provider. The vehicle provider can utilize a vehicle provider computing system that is remote from the autonomous vehicle 105 to communicate (e.g., over one or more wireless communication channels) with the vehicle computing system 100 of the autonomous vehicle 105. The vehicle provider computing system can include a server system (e.g., of an entity), a user device (e.g., of an individual owner), and/or other types of computing systems.

The autonomous vehicle 105 can be configured to perform vehicle services for one or more service entities. An autonomous vehicle 105 can perform a vehicle service by, for example, travelling (e.g., traveling autonomously) to a location associated with a requested vehicle service, allowing user(s) 195 and/or item(s) to board or otherwise enter the autonomous vehicle 105, transporting the user(s) 195 and/or item(s), allowing the user(s) 195 and/or item(s) to deboard or otherwise exit the autonomous vehicle 105, etc. In this way, the autonomous vehicle 105 can provide the vehicle service(s) for a service entity to a user 195.

A service entity can be associated with the provision of one or more vehicle services. For example, a service entity can be an individual, a group of individuals, a company (e.g., a business entity, organization, etc.), a group of entities (e.g., affiliated companies), and/or another type of entity that offers and/or coordinates the provision of one or more vehicle services to one or more users 195. For example, a service entity can offer vehicle service(s) to users 195 via one or more software applications (e.g., that are downloaded onto a user computing device), via a website, and/or via other types of interfaces that allow a user 195 to request a vehicle service. As described herein, the vehicle services can include transportation services (e.g., by which a vehicle transports user(s) 195 from one location to another), delivery services (e.g., by which a vehicle transports/delivers item(s) to a requested destination location), courier services (e.g., by which a vehicle retrieves item(s) from a requested origin location and transports/delivers the item to a requested destination location), and/or other types of services.

Each service entity can be associated with a respective telecommunications network system of that service entity. A telecommunications network system can include the infrastructure to facilitate communication between the autonomous vehicle 105 and the various computing systems of the associated service entity that are remote from the autonomous vehicle 105. For example, a service entity can utilize an operations computing system 200 to communicate with, coordinate, manage, etc. autonomous vehicle(s) to perform the vehicle services of the service entity. A telecommunications network system can allow an autonomous vehicle 105 to utilize the back-end functionality of the respective operations computing system 200 (e.g., service assignment allocation, vehicle technical support, etc.).

An operations computing system 200 can include one or more computing devices that are remote from the autonomous vehicle 105 (e.g., located off-board the autonomous vehicle 105). For example, such computing device(s) can be components of a cloud-based server system and/or other type of computing system that can communicate with the vehicle computing system 100 of the autonomous vehicle 105, another computing system (e.g., a vehicle provider computing system, etc.), a user device, etc. The operations computing system 200 can be or otherwise included in a data center for the service entity, for example. The operations computing system can be distributed across one or more location(s) and include one or more sub-systems. The computing device(s) of an operations computing system 200 can include various components for performing various operations and functions. For instance, the computing device(s) can include one or more processor(s) and one or more tangible, non-transitory, computer readable media (e.g., memory devices, etc.). The one or more tangible, non-transitory, computer readable media can store instructions that when executed by the one or more processor(s) cause the operations computing system (e.g., the one or more processors, etc.) to perform operations and functions, such as communicating data to and/or obtaining data from vehicle(s), etc.

In some implementations, the operations computing system 200 and the vehicle computing system 100 can indirectly communicate. For example, a vehicle provider computing system can serve as an intermediary between the operations computing system and the vehicle computing system 100 such that at least some data is communicated from the operations computing system 200 (or the vehicle computing system 100) to the vehicle provider computing system and then to the vehicle computing system 100 (or the operations computing system 200). In some implementations, the operations computing system 200 can be configured to assist in determining sensor degradation conditions, as described herein.

Referring now to FIG. 2, an example sensor 205 according to example aspects of the present disclosure is depicted. Sensor 205 can be, for example, a RADAR sensor, a LIDAR sensor, an ultrasonic sensor, a wheel encoder, a steering angle sensor, a positioning sensor (e.g., GPS sensor), a camera, an inertial measurement unit, or other sensor of an autonomous vehicle.

For example, in some implementations, a sensor 205 can include an analog front end (“AFE”) 210 configured to send out a first signal 215 (e.g., a radio wave signal, a light signal, etc.), and receive a second signal 220 (e.g., a reflected signal). For example, the second signal 220 can be received by the AFE 210 when the first signal 215 reflects off of one or more objects within a field of view of the sensor 205. In some implementations, the AFE 210 can be configured to receive signals 220, such as visible spectrum signals, without sensor 205 sending out a first signal 215. For example, in some implementations, AFE 210 can receive the signal 220 when ambient light reflects off of objects within the field of view of the sensor 205.

As shown in FIG. 2, in some implementations, a sensor 205 can include two or more parallel processing pipelines, each of which can be configured to provide sensor data. For example, a first pipeline can be configured to provide detection level data 230, and a second processing pipeline can be configured to provide processed data 255.

For example, a first signal processing pipeline can include a signal converter 225. Signal converter 225 can be configured to receive analog signals from AFE 210 and convert the analog signals into digital signals. For example, signal converter 225 can convert analog signals received from AFE 210 into detection level data 230 suitable for use by one or more computing devices, such as a vehicle autonomy system 130 depicted in FIG. 1. The detection level data can be, for example, minimally processed or raw data received from the sensor, such as a point cloud from a LIDAR sensor.

A second signal processing pipeline can include one or more signal converters 235, one or more filters 240, one or more object tracking modules 245, and/or one or more command modules 245. For example, signal converter 235 can be configured to receive analog signals from AFE 210, and convert the analog signals into digital signals. In some implementations, as shown, one or more filters 240 can be configured to filter the signals received from signal converter 235. For example, the one or more filters 240 can be high-pass filters, low-pass filters, bandpass filters, or other filters. In some implementations, the one or more filters 240 can be configured to filter the analog signal received from the AFE 210 before providing the analog signal to the signal converter 235.

The one or more object tracking modules 245 can be configured to track objects perceived by the sensor 205. For example, in some implementations, the sensor 205 can be configured to send multiple successive signals 215, and in response, receive multiple successive signals 220. The one or more object tracking modules 245 can be configured to track objects by, for example, comparing two or more received signals 220. In some implementations, the one or more object tracking modules 245 can include, for example, hardware and/or software configured to implement one or more object tracking algorithms. For example, the sensor 205 can be a camera configured to obtain successive frames of imagery data, and the one or more object tracking modules 245 can track objects depicted within the imagery frames over successive frames using image processing techniques. In some implementations, the one or more object tracking modules 245 can be configured to output state data indicative of a state of an object detected by the sensor 205 as processed data 255. For example, the state data indicative of the state of an object can include data indicative of a position, a velocity, acceleration, a heading, a yaw rate, a shape, a size, an object type, or a distance from the autonomous vehicle (or the sensor 205), as described herein.

In some implementations, the one or more command modules 250 can be configured to output vehicle controller commands as processed data 255. For example, the one or more command modules 250 can be configured to receive state data indicative of a state of an object (e.g., an object velocity and heading) from the one or more object tracking modules 245 and output vehicle controller commands in response. For example, as part of an adaptive cruise control system, a sensor 205 can be configured to output vehicle control commands (e.g., brake commands, steering commands) via an onboard command module 250 as part of and/or in conjunction with a vehicle autonomy system 130.

Thus, as depicted in FIG. 2, a sensor 205 can include multiple parallel processing pipelines, and can be configured to provide both detection level data as well as processed data. Further, in some implementations, a second processing pipeline can be configured to implement various algorithms on the detection level data 230 from a first processing pipeline to generate processed data 255, such as via object tracking modules 245, command modules 250, etc. Although FIG. 2 depicts a sensor 205 with two parallel processing pipelines, it should be noted that any number of processing pipelines can be included in a sensor 205. Moreover, while FIG. 2 depicts various components which can be included in processing pipelines, such as signal converters 225/235, filters 240, object tracking modules 240, and command modules 250, it should be noted that other signal processing components can also be included in a processing pipeline and can be arranged in a processing pipeline in any suitable manner.

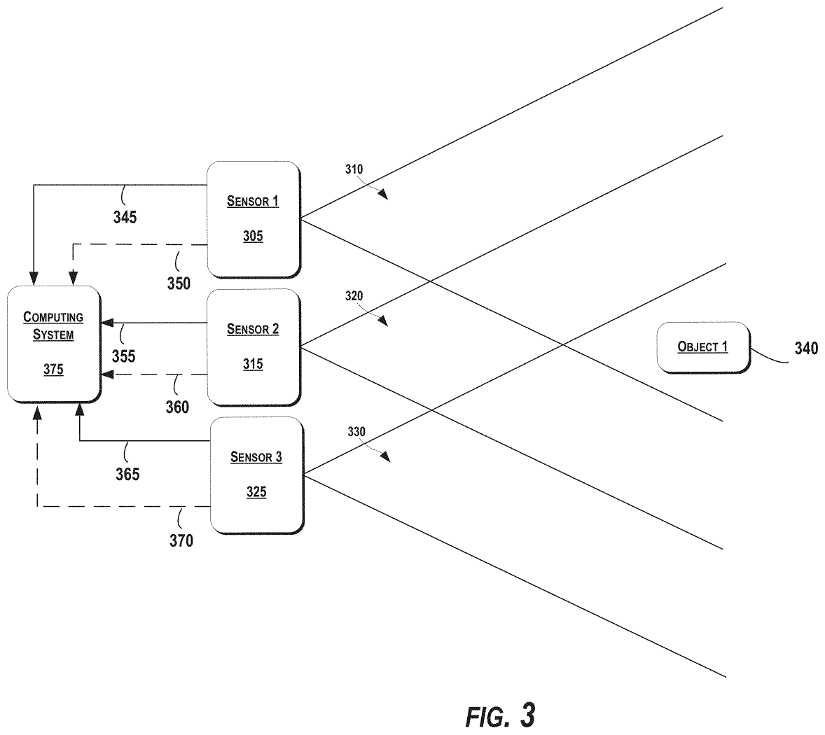

Referring now to FIG. 3, a plurality of example sensors and corresponding fields of view are depicted according to example aspects of the present disclosure. For example, as shown, three sensors 305/315/325 have overlapping fields of view 310/320/330, respectively, and object 340 is positioned within the respective fields of view 310/220/330 of each sensor 305/315/325. Each sensor 305/315/325 can be, for example, a LIDAR sensor, an ultrasonic sensor (e.g., sonar), a RADAR sensor, an inertial measurement unit, a wheel encoder, a steering angle sensor, a positioning sensor (e.g., GPS sensor), a camera, or other sensor of an autonomous vehicle, as described herein. In some implementations, the sensors 305/315/325 can be the same type of sensor (e.g., all sensors are RADAR sensors), while in other implementations, the sensors 305/315/325 can be two or more different types of sensors (e.g., two RADAR sensors and a camera; a LIDAR sensor, a RADAR sensor, and a camera; etc.).

Each sensor 305/315/325 can be configured to provide sensor data comprising first data and second data, as described herein. For example, first sensor 305 can provide detection level data 345 (depicted with a solid line) and processed data 350 (depicted with a dashed line). Similarly, second sensor 315 and third sensor 325 can provide detection level data 355/365 and processed data 360/370. A computing system 375 can receive (e.g., obtain) the detection level data 345/355/365 and the processed data 350/360/370 from each respective sensor 305/315/325. The computing system 375 can be, for example, a vehicle computing system 100 and/or an autonomy computing system 130 depicted in FIG. 1. The detection level data 345/355/365 can be, for example, raw or minimally processed sensor data, and the processed data 350/360/370 can be, for example, state data indicative of a state of the object 340, as described herein.

In some implementations, the computing system 375 can aggregate detection level data 345/355/365 from a plurality of sensors 305/215/325 to determine aggregated data. For example, the detection level data 345/355/365 can be combined to determine aggregated data indicative of a state of an object 340 detected by a plurality of sensors 305/315/325. For example, sensors 305/315 can be RADAR sensors, and detection level data 345/355 from the sensors 305/315 can be aggregated (e.g., combined) by the computing system 375 to determine one or more of a position, a velocity, an acceleration, a heading, a yaw rate, a shape, a size, a type of object 340, or a distance of the object 340 from the autonomous vehicle. For example, the computing system 375 can use known relationships of the sensors 305/315 and/or various algorithms, such as via a perception system of the autonomous vehicle, to aggregate the detection level data 345/355/365.

In some implementations, the computing system 375 can aggregate detection level data 345/355/365 from two or more sensors 305/315/325 which are the same type of sensor. For example, two or more sensors 305/315/325 can be LIDAR sensors, RADAR sensors, camera sensors, or other sensors as described herein. In some implementations, the computing system 375 can aggregate detection level data 345/355/365 from two sensors 305/315/325 which are not the same type of sensor (e.g., two sensors 305/315/325 are different). For example, the first sensor 305 can be a LIDAR sensor, and the second sensor 315 can be a RADAR sensor. In implementations in which the first sensor 305 and the second sensor 315 are of different types, the computing system 375 can compare common attributes of the respective sensor data, such as data indicative of objects perceived by the respective sensors. As an example, a camera can provide detection level data 345/355/365 indicative of a lateral position of an object 340, and a RADAR sensor can provide detection level data 345/355/365 indicative of a longitudinal position of the object 340. In some implementations, the respective sensor data can include data indicative of object types, positions, velocities, etc.

According to example aspects of the present disclosure, the computing system 375 can determine a sensor degradation condition for a sensor 305/315/325 based at least in part on the sensor data obtained by the computing system 375. For example, in some implementations, the computing system 375 can compare aggregated data, such as aggregated data indicative of a state of the object 340, to processed data received from at least one sensor 305/315/325. For example, if processed data 350 from a first sensor 305 indicates an object 340 is a particular object type (e.g., a tree), whereas aggregated data from a plurality of sensors 305/315/325 indicates that the object 340 is a different object type (e.g., a bicycle), the mismatch can indicate the first sensor 305 is not operating properly.

Similarly, if the processed data 350 from the first sensor 305 indicates the first sensor 305 does not perceive the particular object 340 (e.g., the sensor does not “see” or otherwise detect the particular object 340), whereas aggregated data from a plurality of sensors 305/315/325 does perceive the particular object 340, the computing system 375 may determine that first sensor 305 is experiencing a sensor degradation condition. For example, something may be defective with the first sensor 305 (e.g., an internal defect may be preventing the first sensor from perceiving the object), the sensor 305 may be misaligned such that the object 340 is not within the field of view of the first sensor 305, or an occlusion may be preventing the first sensor 305 from perceiving the object 340 (e.g., another object or debris is blocking the field of view of the first sensor 305).

As another example, if aggregated data from a plurality of sensors 305/315/325 is indicative of a particular state of a particular object 340, and processed data 350/360/370 from a first sensor 305 is also indicative of the particular state of the particular object 340 (e.g., the processed data 350 from the first sensor 305 confirms the aggregated data), the computing system may 375 determine that the first sensor 305 is not experiencing a sensor degradation condition. If, however, processed data 360 from a second sensor 315 is not indicative of the particular state of the particular object 340 (e.g., the processed data 360 from the second sensor 315 conflicts with the aggregated data and/or the processed data 350 from the first sensor 305), the computing system 375 can determine that the second sensor 315 is experiencing a sensor degradation condition.

In some implementations, the detection level data 345 from the first sensor 305 can be included in the aggregated data which is compared to processed data 350 from the first sensor 305, whereas in other implementations, the aggregated data can be determined using detection level data 360/370 from a plurality of sensors 315/325 which does not include the first sensor 305. For example, in some implementations, the processed data 350 from first sensor 305 can be compared to aggregated data determined using detection level data 355/365 from sensors 315/325 to determine whether the processed data 350 from first sensor 305 is accurate. Alternatively, in some implementations, the processed data 350 from first sensor 305 can be compared to aggregated data determined using detection level data 345/355 from sensors 305/315 to confirm whether the aggregated data is consistent with processed data 350.

In some implementations, processed data 350 from a first sensor 305 can be compared to processed data 360/370 from sensors 315/325. For example, if two sensors 315/325 both determine that an object 340 is traveling at a certain velocity, whereas the processed data 350 from the first sensor indicates the object 340 is traveling at a different velocity, the computing system 375 may determine that the first sensor 305 is experiencing a sensor degradation condition affecting the processed data 350 pipeline.

In some implementations, detection level data 345/355/365 from one or more sensors 305/315/325 can be compared to detection level data 345/355/365 from one or more other sensors 305/315/325. For example, a first sensor 305 can be a wheel encoder, an inertial measurement unit, a steering angle sensor, or other type of sensor, and detection level data 345 from the sensor 305 can indicate that the autonomous vehicle is turning. The detection level data 345 can be compared to detection level data 355/365 from one or more other sensors 315/325 (e.g., one or more cameras) to determine if the one or more other sensors 315/325 are experiencing a sensor degradation condition. For example, if a pixel (or group of pixels) in detection level data 355 from a second sensor 315 which is a camera sensor does not move as expected (e.g., an object represented by the pixel does not shift in the camera's field of view due to the turning of the autonomous vehicle), the computing system 375 may determine that the second sensor 315 is experiencing a sensor degradation condition affecting the detection level data 355. In some implementations, detection level data 365 from a third sensor 325 (or additional sensors) can also be included in the comparison. For example, detection level data 365 from a third sensor 325 (e.g., an inertial measurement unit, another camera, etc.) may also indicate that the vehicle is turning, which can be used to confirm that the second sensor 315 is experiencing a sensor degradation condition.

Thus, a computing system 375 can use detection level data 345/355/365 from a plurality of sensors 305/315/325 and/or processed data 350/360/370 from one or more sensors 305/315/325 to determine whether a particular sensor 305/315/325 is experiencing a sensor degradation condition.

In some implementations, the computing system 375 can be configured to account for sensor data latency differences. For example, processed data 350/360/370 generated by a particular sensor 305/315/325 may have a slower latency as compared to detection level data 345/355/365 generated by the same or other sensors 305/315/325. The computing system 375 can be configured to account for such latency differences by, for example, selecting detection level data 345/355/365 and processed data 350/360/370 from corresponding time periods for comparison.

In some implementations, the computing system 375 can determine whether a sensor degradation condition is a temporary sensor degradation condition for a permanent sensor degradation condition. For example, the computing system 375 may be able to run one or more diagnostics on a sensor 305/315/325 experiencing a sensor degradation condition in order to determine whether the sensor degradation condition is temporary (e.g., a temporarily blocked field of view) or permanent (e.g., an internal defect). For example, imagery processing techniques can be used to determine whether debris is occluding a camera, or an object 340 perceived by one or more sensors as the autonomous vehicle proceeds along a motion path can be determined to be blocking a field of view of another sensor 305/315/325.

In some implementations, the computing system 375 can determine that a particular sensor 305/315/325 is experiencing a misalignment condition by, for example, using known relationships between the orientation of various sensors 305/315/325. For example, if a first sensor 305 has a field of view 310 which overlaps with a field of view 320 of a second sensor 315, and the first sensor 305 generates processed data 350 indicating an object 340 should be located in a particular portion of the field of view 320 of the second sensor 315, but processed data 360 from the second sensor 315 indicates the object is within a different portion of the field of view 320 of the second sensor 315, the computing system 375 can determine that the second sensor 315 may be experiencing a misalignment condition. Similarly, aggregated detection level data 345/355/365 from a plurality of sensors 305/315/325 can be compared to processed data 350/360/370 from a particular sensor 305/315/325 to determine whether the particular sensor 305/315/325 is experiencing a misalignment condition. For example, aggregated detection level data 355/365 from sensors 315/325 can indicate an object 340 should be within the field of view 310 of sensor 305. If, however, object 340 is missing from the field of view 310 of sensor 305 or if object 340 is in a wrong position of the field of view 310 of sensor 305, sensor 305 may be misaligned.

Further, in some implementations, the computing system 375 can implement a sensor correction action based at least in part on the sensor degradation condition. For example, in some implementations, the sensor correction action can include adjusting a weighting parameter associated with a sensor 305/315/325.

For example, a perception system can assign respective weighting parameters to each of a plurality of sensors 305/315/325 which provide detection level data 345/355/365 when the detection level data 345/355/365 is aggregated by the perception system. The weighting parameters can correspond to a respective confidence level for each sensor 305/315/325. For example, if sensor data from a particular sensor 305 contains a high level of noise or if a particular sensor 305 has a low confidence level in an object classification, the perception system can deprioritize the sensor 305 as compared to one or more other sensors 315/325 of the autonomous vehicle. Similarly, the perception system can deprioritize either the detection level data 345 or the processed data 350 from the sensor 305 as compared to the other type of data. For example, the perception system can assign a higher weighting parameter to processed data 350 and a lower weighting parameter to the detection level data 345 from the sensor 305. In some implementations, adjusting a weighting parameter can include ignoring one or more sensor data streams from a particular sensor 305. For example, if the computing system 375 determines that the processed data 350 pipeline of the sensor 305 is experiencing a sensor degradation condition, the computing system 375 can disregard the processed data 350 from the sensor 305 until the sensor degradation condition has been remedied.

In some implementations, a sensor correction action can include scheduling maintenance for a sensor 305/315/325. For example, a computing system 375 onboard an autonomous vehicle can communicate with a remote computing system (e.g., an operations computing system 200 depicted in FIG. 1), and can schedule the autonomous vehicle to be routed to an autonomous vehicle inspection facility for maintenance. For example, a sensor 305 experiencing a misalignment condition can be realigned to the correct alignment.

In some implementations, a sensor correction action can include cleaning a sensor 305/315/325. For example, an autonomous vehicle may be equipped with a sensor cleaning system, which can use liquid and/or gas sensor cleaning units to clean sensors 305/315/325 of the autonomous vehicle. For example, when the computing system 375 determines that a camera sensor is experiencing a temporary occlusion condition, such as debris on a lens of the camera, the computing system 375 can cause the sensor cleaning system to clean the debris from the lens of the camera by, for example, sending control signals to the sensor cleaning system.

In some implementations, a sensor correction action can include performing a sensor diagnostic action on a sensor 305/315/325. For example, in some implementations, a sensor 305 can be configured to run one or more diagnostic algorithms to evaluate whether the sensor 305 is operating correctly. In some implementations, the diagnostic algorithms can be performed as part of a processed data 350 pipeline. In some implementations, the diagnostic algorithms can be performed as part of a perception system, such as by aggregating detection level data 345/355/365 from a plurality of sensors 305/315/325 and evaluating the aggregated data using a diagnostic algorithm. For example, aggregated detection level data 345/355/365 from sensors 305/315/325 can be compared to aggregated detection level data 355/365 from sensors 315/325 to determine whether sensor 305 is operating correctly.

In some implementations, a sensor correction action can include operating the autonomous vehicle to a safe state in which autonomous operation is disabled. For example, if a sensor 305 is experiencing a defective condition, such as due to an internal defect, the computing system 375 can implement a motion plan to operate the vehicle to a safe state, such as navigating the autonomous vehicle to a stop in a parking lot, and autonomous operation can be disabled. In some implementations, the autonomous vehicle may only be able to operate in a manual operating mode until the sensor degradation condition has been remedied, such as by repairing or replacing the sensor 305.

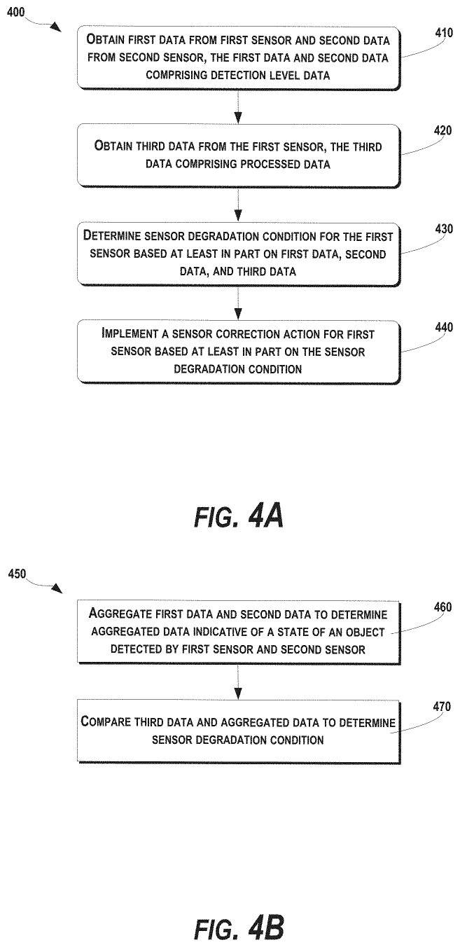

FIG. 4A depicts a flow diagram of an example method 400 for determining a sensor degradation condition according to example aspects of the present disclosure. One or more portion(s) of the method 400 can be implemented by a computing system that includes one or more computing devices such as, for example, the computing systems described with reference to the other figures (e.g., a vehicle computing system 100, an operations computing system 200, a computing system 375, etc.). Each respective portion of the method 400 can be performed by any (or any combination) of one or more computing devices. Moreover, one or more portion(s) of the method 400 can be implemented as an algorithm on the hardware components of the device(s) described herein (e.g., as in FIGS. 1, 2, 3, 6, and/or 7), for example, to determine sensor degradation conditions for sensors of an autonomous vehicle and, in response, implement correction actions. FIG. 4A depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 4A is described with reference to elements/terms described with respect to other systems and figures for example illustrated purposes and is not meant to be limiting. One or more portions of method 400 can be performed additionally, or alternatively, by other systems.

At (410), the method 400 can include obtaining first data from a first sensor of an autonomous vehicle and second data from a second sensor of the autonomous vehicle. The first data and the second data can include detection level data. For example, the detection level data can be raw or minimally processed data obtained from the first sensor and the second sensor. In some implementations, the first sensor and/or the second sensor can include a LIDAR sensor, a RADAR sensor, or a camera sensor. In some implementations, the first sensor and the second sensor can be the same type of sensor. In other implementations, the first sensor and the second sensor can be different types of sensors.

At (420), the method 400 can include obtaining third data from the first sensor. The third data can include processed data. For example, the processed data can be data which has been processed by a parallel processing pipeline, and can include data which has been filtered, converted, and/or generated by one or more data processing modules, such as object tracking modules, command modules, etc. In some implementations, the third data can include state data indicative of a state of an object detected by the first sensor. For example, the state data can include data indicative of the state of the object, such as data indicative of a position, a velocity, an acceleration, a heading, a yaw rate, a shape, a size, an object type, or a distance from the autonomous vehicle.

At (430), the method 400 can include determining a sensor degradation condition for the first sensor based at least in part on the first data, the second data, and the third data. In some implementations, the method 400 can include determining whether the sensor degradation condition is a temporary sensor degradation condition or a permanent sensor degradation condition. In some implementations, the sensor degradation condition can be a misalignment condition, an occlusion condition, or a defective condition, as described herein.

In some implementations, the method can include obtaining fourth data from a third sensor and/or other data from any number of sensors. The data can be, for example, detection level data and/or processed data. The computing system can determine the sensor degradation condition based at least in part on the fourth data, or other data.

In some implementations, the computing system can determine the sensor degradation condition by aggregating the first data and the second data. For instance, FIG. 4B depicts a flow diagram of an example method 450 for determining a sensor degradation condition according to example aspects of the present disclosure. One or more portion(s) of the method 450 can be implemented by a computing system that includes one or more computing devices such as, for example, the computing systems described with reference to the other figures (e.g., a vehicle computing system 100, an operations computing system 200, a computing system 375, etc.). Each respective portion of the method 450 can be performed by any (or any combination) of one or more computing devices. Moreover, one or more portion(s) of the method 450 can be implemented as an algorithm on the hardware components of the device(s) described herein (e.g., as in FIGS. 1, 2, 3, 6. and/or 7). FIG. 4B depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 4B is described with reference to elements/terms described with respect to other systems and figures for example illustrated purposes and is not meant to be limiting. One or more portions of method 450 can be performed additionally, or alternatively, by other systems.

At (460), the method 450 can include aggregating the first data and the second data to determine aggregated data indicative of a state of an object detected by the first sensor and the second sensor. For example, a perception system of an autonomous vehicle can aggregate the first data and the second data by, for example, combining the data in order to determine state data indicative of a state of an object. For example, the state data can include data indicative of a position, a velocity, acceleration, a heading, a yaw rate, a shape, a size, an object type, or a distance from the autonomous vehicle.

At (470), the method 450 can include comparing the third data and the aggregated data to determine the sensor degradation condition. For example, the third data (e.g., processed data) can be compared to the aggregated data to see whether the processed data confirms the detection level data, or vice versa. If the aggregated data and the processed data are in conflict, then the computing system can determine that a sensor degradation condition exists by, for example, using the techniques described herein.

Returning to FIG. 4A, at (440), the method 400 can include implementing a sensor correction action for the first sensor based at least in part on the sensor degradation condition. For example, in some implementations, the sensor correction action can include adjusting a weighting parameter associated with the first sensor, scheduling maintenance for the first sensor, cleaning the first sensor, performing a sensor diagnostic action on the first sensor, or operating the autonomous vehicle to a safe state. For example, in some implementations, adjusting a weighting parameter associated with the first sensor can include deprioritizing the first sensor as compared to at least one other sensor of the autonomous vehicle, as described herein. In some implementations adjusting a weighting parameter associated with the first sensor can include deprioritizing the first data (e.g., detection level data) or the third data (e.g., processed data) from the first sensor as compared to the other of the first data (e.g., detection level data) or the third data (e.g., processed data).

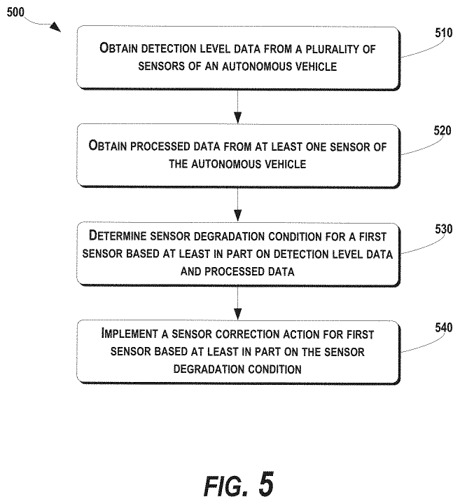

FIG. 5 depicts a flow diagram of an example method 500 for determining a sensor degradation condition according to example aspects of the present disclosure. One or more portion(s) of the method 500 can be implemented by a computing system that includes one or more computing devices such as, for example, the computing systems described with reference to the other figures (e.g., a vehicle computing system 100, an operations computing system 200, a computing system 375, etc.). Each respective portion of the method 400 can be performed by any (or any combination) of one or more computing devices. Moreover, one or more portion(s) of the method 500 can be implemented as an algorithm on the hardware components of the device(s) described herein (e.g., as in FIGS. 1, 2, 3, 6, and/or 7), for example, to determine sensor degradation conditions for sensors of an autonomous vehicle and, in response, implement correction actions. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 5 is described with reference to elements/terms described with respect to other systems and figures for example illustrated purposes and is not meant to be limiting. One or more portions of method 500 can be performed additionally, or alternatively, by other systems.

At (510), the method 500 can include obtaining detection level data from a plurality of sensors of an autonomous vehicle. For example, the detection level data can be obtained from LIDAR sensors, RADAR sensors, cameras, inertial measurement units, and/or other sensors of an autonomous vehicle. In some implementations, each sensor of the plurality of sensors can be the same type of sensor, while in other implementations, the plurality of sensors can include sensors of different types.

At (520), the method 500 can include obtaining processed data from at least one sensor of the autonomous vehicle. In some implementations, the processed data can include state data indicative of a state of an object detected by the at least one sensor. For example, the state data can include data indicative of a position, a velocity, an acceleration, a heading, a yaw rate, a shape, a size, an object type, or a distance from the autonomous vehicle. In some implementations, the at least one sensor can be a sensor included in the plurality of sensors. In other implementations, the at least one sensor can be a different sensor which is not included in the plurality of sensors. In some implementations, the at least one sensor can be a different type of sensor from one or more sensors of the plurality of sensors, while in other implementations, the at least one sensor can be the same type of sensor as the plurality of sensors.

At (530), the method 500 can include determining a sensor degradation condition for a first sensor of the autonomous vehicle based at least in part on the detection level data and the processed data. For example, in some implementations, a computing system can aggregate the detection level data obtained from the plurality of sensors to determine aggregated data indicative of a state of an object detected by the plurality of sensors, as described herein. Further, in some implementations, the computing system can compare the processed data and the aggregated data to determine the sensor degradation condition. In some implementations, the sensor degradation condition can include one or more of a misalignment condition, an occlusion condition, or a defective condition. In some implementations, the computing system can determine whether the sensor degradation condition is a temporary condition or a permanent condition, as described herein.

In some implementations, the first sensor can be the at least one sensor. For example, the computing system can determine that the sensor degradation condition is occurring for the same sensor from which the processed data was obtained. In other implementations, the first sensor can be a different sensor. In some implementations, the computing system can determine that the sensor degradation condition is occurring for one of the sensors in the plurality of sensors. In other implementations, the first sensor can be a sensor not in the plurality of sensors.

At (540), the method can include implementing a sensor correction action for the first sensor based at least in part on the sensor degradation condition. For example, in some implementations, the sensor correction action can include one or more of adjusting a weighting parameter associated with the first sensor, scheduling maintenance for the first sensor, cleaning the first sensor, performing a sensor diagnostic action on the first sensor, or implementing a safe stop action for the autonomous vehicle, as described herein.

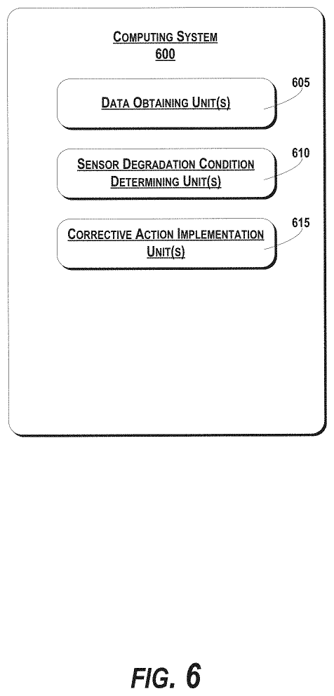

Various means can be configured to perform the methods and processes described herein. For example, FIG. 6 depicts a diagram of an example a computing system 600 that includes various means according to example aspects of the present disclosure. The computing system 600 can be and/or otherwise include, for example, the vehicle computing system 100, the operations computing system 200, the computing system 375, etc. The computing system 600 can include data obtaining unit(s) 605, sensor degradation determining unit(s) 610, corrective action implementation unit(s) 615, and/or other means for performing the operations and functions described herein. In some implementations, one or more of the units may be implemented separately. In some implementations, one or more units may be a part of or included in one or more other units.

These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. Certain means can include other types of devices. For instance, the corrective action implementation unit(s) 615 can include sensor cleaning units, etc.

The means can be programmed to perform one or more algorithm(s) for carrying out the operations and functions described herein. For instance, the means can be programmed to perform one or more algorithm(s) for carrying out the operations and functions described herein. For instance, the means (e.g., the data obtaining unit(s) 605) can be configured to obtain sensor data from one or more sensors, such as detection level data and/or processed data (e.g., from one or more sensors of an autonomous vehicle).

The means (e.g., the sensor degradation condition determining unit(s) 610) can be configured to determine a sensor degradation condition for a sensor of the autonomous vehicle. For instance, the means (e.g., the sensor degradation condition determining unit(s) 610) can be configured to determine when a sensor is experiencing a sensor degradation condition, such as a misalignment condition, an occlusion condition, and/or a defective condition, as described herein. The means (e.g., the sensor degradation condition determining unit(s) 610) can be configured to perform various algorithms, such as aggregating detection level data, comparing processed data to other sensor data, etc., as described herein. The means (e.g., the sensor degradation condition determining unit(s) 610) can be configured to determine whether a sensor degradation condition is a permanent degradation condition or a temporary degradation condition, as described herein.

The means (e.g., the corrective action implementation unit(s) 615) can implement a sensor corrective action in response to determining a sensor degradation condition for a sensor. For example, the means (e.g., the corrective action implementation unit(s) 615) can adjust a weighting parameter associated with the sensor, schedule maintenance for the sensor, clean the sensor, perform a sensor diagnostic action on sensor, or implement a safe stop action for the autonomous vehicle.

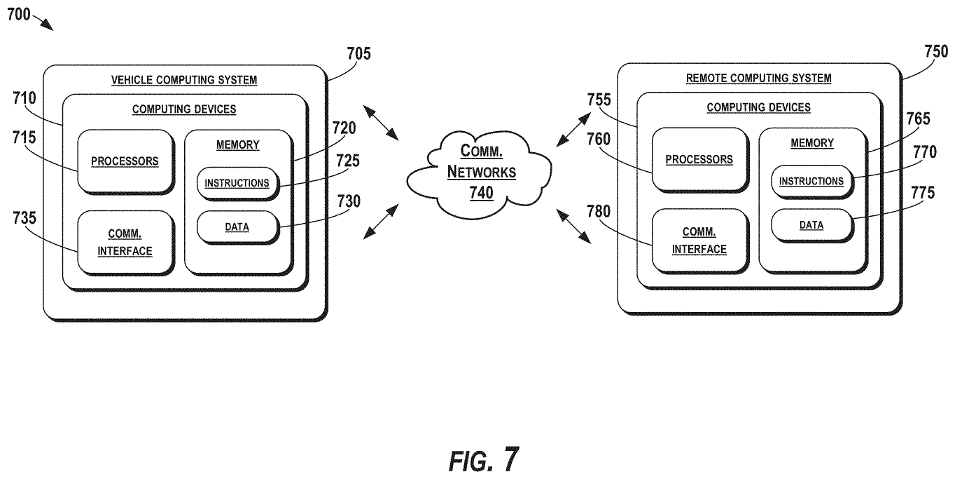

FIG. 7 depicts an example system 700 according to example aspects of the present disclosure. The example system 700 illustrated in FIG. 7 is provided as an example only. The components, systems, connections, and/or other aspects illustrated in FIG. 7 are optional and are provided as examples of what is possible, but not required, to implement the present disclosure. The example system 700 can include a vehicle computing system 705 of a vehicle. The vehicle computing system 705 can represent/correspond to the vehicle computing systems 100, 375 described herein. The example system 700 can include a remote computing system 750 (e.g., that is remote from the vehicle computing system). The remote computing system 750 can represent/correspond to an operations computing system 200 described herein. The vehicle computing system 705 and the remote computing system 750 can be communicatively coupled to one another over one or more network(s) 740.

The computing device(s) 710 of the vehicle computing system 705 can include processor(s) 715 and a memory 720. The one or more processors 715 can be any suitable processing device (e.g., a processor core, a microprocessor, an ASIC, a FPGA, a controller, a microcontroller, etc.) and can be one processor or a plurality of processors that are operatively connected. The memory 720 can include one or more non-transitory computer-readable storage media, such as RAM, ROM, EEPROM, EPROM, one or more memory devices, flash memory devices, data registrar, etc., and combinations thereof.

The memory 720 can store information that can be accessed by the one or more processors 715. For instance, the memory 720 (e.g., one or more non-transitory computer-readable storage mediums, memory devices) on-board the vehicle can include computer-readable instructions 725 that can be executed by the one or more processors 715. The instructions 725 can be software written in any suitable programming language or can be implemented in hardware. Additionally, or alternatively, the instructions 725 can be executed in logically and/or virtually separate threads on processor(s) 715.

For example, the memory 720 can store instructions 725 that when executed by the one or more processors 715 cause the one or more processors 715 (the vehicle computing system 705) to perform operations such as any of the operations and functions of the vehicle computing system 100 (or for which it is configured), one or more of the operations and functions of the vehicle provider computing systems (or for which it is configured), one or more of the operations and functions of the operations computing systems described herein (or for which it is configured), one or more of the operations and functions for determining sensor degradation conditions for sensors of an autonomous vehicle, one or more portions of method(s) 400/450/500, and/or one or more of the other operations and functions of the computing systems described herein.

The memory 720 can store data 730 that can be obtained (e.g., acquired, received, retrieved, accessed, created, stored, etc.). The data 730 can include, for instance, sensor data (e.g., detection level data and/or processed data), map data, vehicle state data, perception data, prediction data, motion planning data, data associated with a vehicle client, data associated with a service entity's telecommunications network, data associated with an API, data associated with a library, state data indicative of a state of an object, data associated with user interfaces, data associated with user input, and/or other data/information such as, for example, that described herein. In some implementations, the computing device(s) 710 can obtain data from one or more memories that are remote from the vehicle computing system 705.

The computing device(s) 710 can also include a communication interface 735 used to communicate with one or more other system(s) on-board a vehicle and/or a remote computing device that is remote from the vehicle (e.g., of the system 750). The communication interface 735 can include any circuits, components, software, etc. for communicating via one or more networks (e.g., network(s) 740). The communication interface 735 can include, for example, one or more of a communications controller, receiver, transceiver, transmitter, port, conductors, software and/or hardware for communicating data.

The remote computing system 750 can include one or more computing device(s) 755 that are remote from the vehicle computing system 705. The computing device(s) 755 can include one or more processors 760 and a memory 765. The one or more processors 760 can be any suitable processing device (e.g., a processor core, a microprocessor, an ASIC, a FPGA, a controller, a microcontroller, etc.) and can be one processor or a plurality of processors that are operatively connected. The memory 765 can include one or more tangible, non-transitory computer-readable storage media, such as RAM, ROM, EEPROM, EPROM, one or more memory devices, flash memory devices, data registrar, etc., and combinations thereof.

The memory 765 can store information that can be accessed by the one or more processors 760. For instance, the memory 765 (e.g., one or more tangible, non-transitory computer-readable storage media, one or more memory devices, etc.) can include computer-readable instructions 770 that can be executed by the one or more processors 760. The instructions 770 can be software written in any suitable programming language or can be implemented in hardware. Additionally, or alternatively, the instructions 770 can be executed in logically and/or virtually separate threads on processor(s) 760.

For example, the memory 765 can store instructions 770 that when executed by the one or more processors 760 cause the one or more processors 760 to perform operations such as any of the operations and functions of the operations computing systems described herein, any operations and functions of the vehicle provider computing systems, any of the operations and functions for which the operations computing systems and/or the vehicle computing systems are configured, one or more of the operations and functions of the vehicle computing system described herein, one or more of the operations and functions for determining sensor degradation conditions for sensors of an autonomous vehicle, one or more portions of method 400/450/500, and/or one or more of the other operations and functions described herein.

The memory 765 can store data 775 that can be obtained. The data 775 can include, for instance, data associated with service requests, communications associated with/provided by vehicles, data to be communicated to vehicles, application programming interface data, data associated with vehicles and/or vehicle parameters, data associated with autonomous vehicle sensors, object data, map data, data associated with user interfaces, data associated with user input, and/or other data/information such as, for example, that described herein.

The computing device(s) 755 can also include a communication interface 780 used to communicate with one or more system(s) onboard a vehicle and/or another computing device that is remote from the system 750. The communication interface 780 can include any circuits, components, software, etc. for communicating via one or more networks (e.g., network(s) 740). The communication interface 780 can include, for example, one or more of a communications controller, receiver, transceiver, transmitter, port, conductors, software and/or hardware for communicating data.

The network(s) 740 can be any type of network or combination of networks that allows for communication between devices. In some embodiments, the network(s) 740 can include one or more of a local area network, wide area network, the Internet, secure network, cellular network, mesh network, peer-to-peer communication link and/or some combination thereof and can include any number of wired or wireless links. Communication over the network(s) 740 can be accomplished, for instance, via a communication interface using any type of protocol, protection scheme, encoding, format, packaging, etc.

Computing tasks, operations, and functions discussed herein as being performed at one computing system herein can instead be performed by another computing system, and/or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

The communications between computing systems described herein can occur directly between the systems or indirectly between the systems. For example, in some implementations, the computing systems can communicate via one or more intermediary computing systems. The intermediary computing systems may alter the communicated data in some manner before communicating it to another computing system.

The number and configuration of elements shown in the figures is not meant to be limiting. More or less of those elements and/or different configurations can be utilized in various embodiments.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for determining degradation in perception sensors of an autonomous vehicle comprising:
obtaining, by a computing system comprising one or more computing devices, first data from a first sensor of an autonomous vehicle and second data from a second sensor of the autonomous vehicle, the first data and the second data comprising detection level data;
obtaining, by the computing system, third data from the first sensor, the third data comprising processed data;
determining, by the computing system, a sensor degradation condition for the first sensor based at least in part on the first data, the second data, and the third data.

2. The computer-implemented method of claim 1, further comprising:
implementing, by the computing system, a sensor correction action for the first sensor based at least in part on the sensor degradation condition.

3. The computer-implemented method of claim 2, wherein the sensor correction action comprises one or more of: adjusting a weighting parameter associated with the first sensor, scheduling maintenance for the first sensor, cleaning the first sensor, performing a sensor diagnostic action on the first sensor, or operating the autonomous vehicle to a safe state.

4. The computer-implemented method of claim 3, wherein adjusting a weighting parameter associated with the first sensor comprises deprioritizing the first sensor as compared to at least one other sensor of the autonomous vehicle or deprioritizing the first data or the third data as compared to the other of the first data or the third data.

5. The computer-implemented method of claim 1, wherein one or more of the first sensor and the second sensor comprise a LIDAR sensor, an ultrasonic sensor, a RADAR sensor, an inertial measurement unit, wheel encoder, steering angle sensor, positioning sensors, or a camera sensor.

6. The computer-implemented method of claim 1, wherein a type of the first sensor and a type of the second sensor are the same.

7. The computer-implemented method of claim 1, wherein the third data comprises state data indicative of a state of an object detected by the first sensor.

8. The computer-implemented method of claim 7, wherein the state data indicative of the state of the object comprises data indicative of one or more of a position, a velocity, an acceleration, a heading, a yaw rate, a shape, a size, an object type, or a distance from the autonomous vehicle.

9. The computer-implemented method of claim 1, wherein determining, by the computing system, the sensor degradation condition for the first sensor based at least in part on the first data, the second data, and the third data comprises determining whether the sensor degradation condition is a temporary sensor degradation condition or a permanent sensor degradation condition.

10. The computer-implemented method of claim 1, wherein determining, by the computing system, the sensor degradation condition for the first sensor based at least in part on the first data, the second data, and the third data comprises:
aggregating the first data and the second data to determine aggregated data indicative of a state of an object detected by the first sensor and the second sensor; and
comparing the third data and the aggregated data to determine the sensor degradation condition.

11. The computer-implemented method of claim 1, further comprising:
obtaining, by the computing system, fourth data from a third sensor, the fourth data comprising detection level data or processed data; and
wherein the sensor degradation condition is further determined based at least in part on the fourth data.

12. The computer-implemented method of claim 1, wherein the sensor degradation condition comprises a misalignment condition, an occlusion condition, or a defective condition.

13. A computing system comprising:
one or more processors; and
one or more tangible, non-transitory, computer readable media that collectively store instructions that when executed by the one or more processors cause the computing system to perform operations comprising:
obtaining detection level data from a plurality of sensors of an autonomous vehicle;
obtaining processed data from at least one sensor of the autonomous vehicle;
determining a sensor degradation condition for a first sensor of the autonomous vehicle based at least in part on the detection level data and the processed data; and
implementing a sensor correction action for the first sensor based at least in part on the sensor degradation condition.

14. The computing system of claim 13, wherein the processed data comprises state data indicative of a state of an object detected by the at least one sensor; and
wherein the state data indicative of the state of the object comprises one or more of a position, a velocity, an acceleration, a heading, a yaw rate, a shape, a size, an object type, or a distance from the autonomous vehicle.

15. The computing system of claim 13, wherein the at least one sensor comprises the first sensor.

16. The computing system of claim 13, wherein the first sensor comprises a sensor of the plurality of sensors.

17. The computing system of claim 13, wherein the at least one sensor comprises a sensor of the plurality of sensors.

18. The computing system of claim 13, wherein determining the sensor degradation condition for the first sensor based at least in part on the detection level data and the processed data comprises:
aggregating the detection level data to determine aggregated data indicative of a state of an object detected by the plurality of sensors; and
comparing the processed data and the aggregated data to determine the sensor degradation condition.

19. An autonomous vehicle, comprising:
a plurality of sensors, each sensor of the plurality configured to provide detection level data and processed data;
one or more processors; and
one or more tangible, non-transitory, computer readable media that collectively store instructions that when executed by the one or more processors cause a computing system to perform operations comprising:
obtaining sensor data from each of the plurality of sensors, the sensor data comprising one or more of detection level data and processed data;
determining a sensor degradation condition for at least one sensor of the plurality based at least in part on the sensor data from the plurality of sensors; and
implementing a sensor correction action for the at least one sensor based at least in part on the sensor degradation condition.

20. The autonomous vehicle of claim 19, wherein the sensor degradation condition comprises a misalignment condition, an occlusion condition, or a defective condition; and
wherein the sensor correction action for the at least one sensor comprises one or more of: adjusting a weighting parameter associated with the at least one sensor, scheduling maintenance for the at least one sensor, cleaning the at least one sensor, performing a sensor diagnostic action on the at least one sensor, or implementing a safe stop action for the autonomous vehicle.
